(19) United States
(12) Patent Application Publication
(10) Pub. No.: US 2012/0026056 A1
(43) Pub. Date: Feb. 2, 2012

(54) RADIO ANTENNA WITH IMPROVED DECOUPLING ANGLES

(75) Inventor: Christian Desagulier, Paris (FR)

(73) Assignee: ASTRIUM SAS, Paris (FR)

(21) Appl. No.: 13/260,833

(22) PCT Filed: Apr. 2, 2010
(86) PCT No.: PCT/EP10/54457

§ 371 Date: Sep. 28, 2011

(30) Foreign Application Priority Data
Apr. 2, 2009 (FR) 0952151

(51) Int. Cl. H01Q 19/10

(52) U.S. Cl. 343/834

(57) ABSTRACT

A radio antenna, particularly for a spacecraft, including a reflector and means of support of this reflector, where the reflector includes a body able to reflect radio waves, and a rigid rear structure supported by the means of support and connected to the body by decoupling angles, wherein each of said decoupling angles includes, at one at least of its ends, a layer of elastic material able to dampen at least one axial component of vibrations of the body.

### TECHNICAL FIELD

The present invention relates to the field of reflector radio antennae, and concerns in particular an antenna for a spacecraft, such as a telecommunications satellite.

### STATE OF THE PRIOR ART

The antennae of spacecrafts must satisfy specifications notably concerning the reflectivity of their reflectors, but also the mechanical properties of the fastenings of the reflectors to the spacecrafts, which are subject to the vibratory, acoustic and dynamic stresses caused by space launchers. These antennae must also satisfy specifications concerning their thermoelastic properties in orbit.

Since the level of acoustic stresses caused by the launchers is very difficult to predict, it is preferable that these antennae should be almost insensitive to acoustic efforts, in order to limit the risks of under-dimensioning or over-dimensioning of the reflectors' fastenings to the spacecrafts.

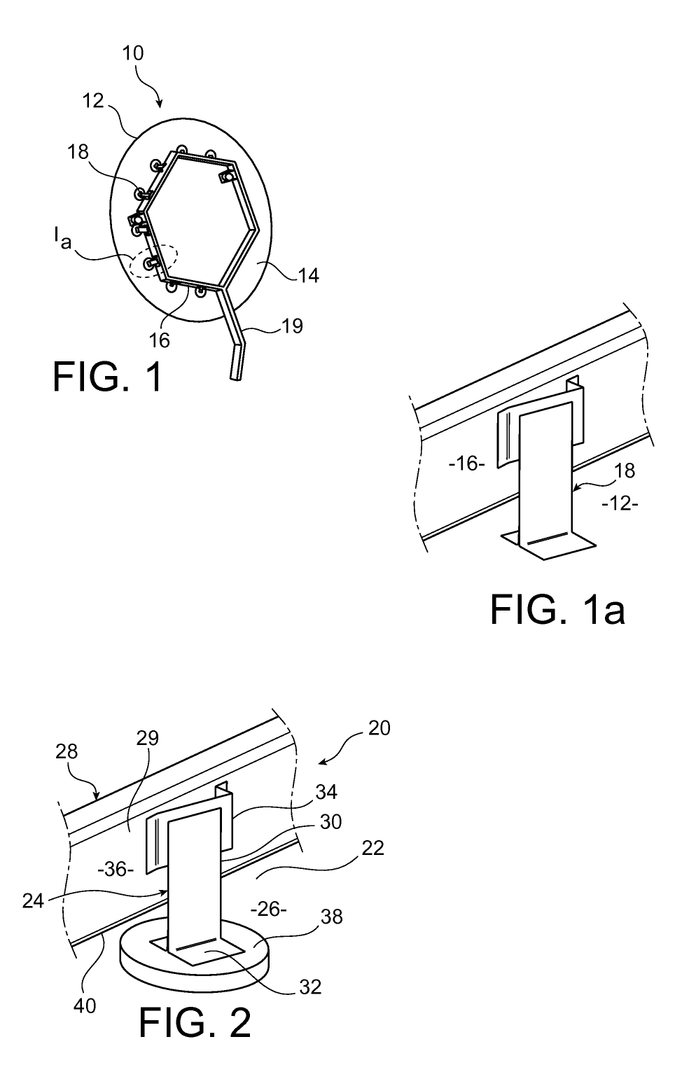

FIGS. 1 and 1a represent an example of a radio antenna 10 (FIG. 1) for a telecommunications satellite, operating at frequencies of between 12 GHz and 18 GHz approximately (Ku band), of a known type.

Reflector 12 of antenna 10 includes a body of the sandwich type formed from a honeycomb structure on to which are affixed a front skin—commonly called the active skin—and a rear skin, where each of these skins consists of a sheet of carbon fibres sunk in an epoxy resin.

Body 14 of reflector 12 is supported by a rigid rear structure 16 of this reflector. The rear structure 16 is, for example, formed from tubular elements positioned in a hexagon shape centred on an axis of the reflector. In the example represented in the figures these tubular elements have, seen in section, a rectangular shape.

Rear structure 16 is connected to the rear skin of body 14 by angles 18 (FIG. 1a) capable of providing the mechanical properties of the antenna at launch and insertion into orbit of the satellite fitted with this antenna, and also a thermomechanical decoupling between reflector 12 and rear structure 16 when the satellite is in orbit. In addition, the rear structure 16 is supported by a support arm 19 intended to provide the connection between the antenna 10 and the satellite.

The carbon fibres of the sheets of the abovementioned front and rear skins are positioned in the form of triaxial fabrics which are characterised by near-isotropic mechanical properties, and by the presence of through-perforations which are regularly distributed over their surface.

These perforations allow the mass of the reflector to be reduced, and communicate with cells in the honeycomb structure, such that this type of reflector is insensitive to vibratory stresses, particularly to acoustic stresses at the launch of the satellite fitted with the antenna 10.

The composite materials used in these antennae generally make them very light, which constitutes an essential advantage in the field of space applications.

However, the reflectivity properties of the perforated reflectors of the type described above are not satisfactory at frequencies of approximately between 20 GHz and 40 GHz (Ka band).

Solutions have been proposed, which consist, using an antenna of the type described above, in reducing the dimensions of the perforations of the active skin, or even in replacing the perforated active skin by an unperforated skin, but the antennae obtained in this manner have proved to be too sensitive to acoustic stresses.

Moreover, at these higher frequencies, the tolerances relative to the profiles of the reflectors are stricter, leading to more severe requirements in terms of manufacturing precision, and of stability over time of the reflectors, typically of the order of 30 μm RMS, which should be compared with 150 μm RMS in the case of satellites operating at the lower frequencies of the Ku band.

And the sandwich structures of the type described above, which include perforated skins formed from a single sheet of composite material, do not easily allow the criteria inherent to operation in the Ka band to be satisfied.

### SUMMARY OF THE INVENTION

One aim of the invention is notably to provide a simple, economic and efficient solution to these problems, allowing the abovementioned disadvantages to be avoided.

Its goal is notably a radio antenna for space satellite, capable of operating at the frequencies of the Ka band, and satisfying the requirements imposed on this type of antenna, notably in respect of the sensitivity of the antenna to the vibratory stresses caused by the launchers, the precision of manufacture of the profile of the antenna's reflector and the stability of this profile over time and, generally, the antenna's thermomechanical properties in orbit.

The invention proposes to this end a radio antenna, particularly for a spacecraft, including a reflector and means of support of this reflector, where the reflector includes a body able to reflect radio waves, and a rigid rear structure supported by the means of support and connected to the body by decoupling angles distributed around an axis of the body, and each including a first base attached to the body of the reflector, a flexible metal blade or a second base attached to the rigid rear structure, and a central metal blade connecting the abovementioned first base to said flexible metal blade or to said second base, and able to dampen a transverse component of vibrations of the body.

According to the invention, each of said decoupling angles includes, at one at least of its ends, a layer of an elastic material able to dampen at least an axial component of vibrations of the body.

In addition, the abovementioned layer of elastic material is interposed between the first base and the body, or between said flexible metal blade or said second base and the rigid rear structure.

Each decoupling angle can thus include either a single layer of elastic material positioned at one of the ends of the angle, or two layers of elastic material respectively positioned at both ends of the angle.

The layer of elastic material of each angle enables the impact of vibratory stresses, notably acoustic stresses, on the means of support of the antenna's reflector to be reduced substantially.

This enables the level of mechanical properties required for the means of support to be limited, thus making the dimensioning of these means of support easier.

In a preferred embodiment of the invention, the reflector's body includes a solid skin, i.e. one which is not perforated.

The great dampening capacity of the angles, as a consequence of their layer of elastic material, indeed makes possible the use of a solid front skin, capable of giving the reflector optimal properties of reflectivity, whilst limiting the risks of under-dimensioning of the reflector's means of support.

In the preferred embodiment of the invention said elastic material has a Young's modulus of between 0.25 MPa and 1 MPa, a traction resistance of between 0.1 MPa and 0.5 MPa, and a breaking elongation of between 20% and 40%.

The layer of elastic material of each angle is thus capable of dampening optimally the vibratory stresses to which the antenna is likely to be subject, particularly when this antenna is fitted to a spacecraft.

In the preferred embodiment of the invention, said elastic material is a foam, and includes at least one compound belonging to the group of polyimides.

Each angle can also include a sandwich structure including two composite material skins affixed either side of said layer of elastic material.

This can, in particular, allow the angles to be attached to the reflector by a method similar to a method habitually used for attaching the angles of the reflectors of the conventional type described above, which may be of substantial economic advantage.

As a variant, the elastic material may include an adhesive including an elastomer, silicon or polyurethane compound.

When the antenna is fitted to a spacecraft, the elastic material is chosen so as not to deteriorate at space operational temperatures in orbit, and more specifically at temperatures of between −180° C. and +200° C.

In the preferred embodiment of the invention, the front skin and the rear skin are made from a composite material including fibres sunk in a hardened resin.

These fibres are advantageously carbon fibres positioned so as to optimise the isotropy of the mechanical and thermal properties of these skins.

To accomplish this said fibres can, for example, be positioned in the form of two sheets of taffeta fabrics intersecting at angles of more or less 45 degrees, or in the form of three to six sheets of layers of fibres draped symmetrically) (0°, +60°, −60°).

These manners of positioning of the fibres also allow the precision and the stability of the profiles of the skins to be improved compared to the skins with a single sheet of conventional reflectors.

Generally, the antenna is advantageously configured to operate in a predetermined band of frequencies of the microwave spectrum, where this band of frequencies can in particular be within the Ka band.

The use of an unperforated active face, made possible by the invention, is indeed particularly advantageous in the Ka band, as was explained above.

### BRIEF DESCRIPTION OF THE ILLUSTRATIONS

The invention will be better understood, and other details, advantages and characteristics of it will appear, on reading the following description given as a non-restrictive example, and with reference to the appended illustrations, in which:

FIG. 1, which has already been described, is a schematic perspective view of a radio antenna of a known type;

FIG. 1a, which has already been described, is a larger-scale view of detail Ia of FIG. 1;

FIG. 2 is a view similar to that of FIG. 1a, of a radio antenna according to the invention.

### DETAILED DESCRIPTION OF A PREFERRED EMBODIMENT

FIG. 2 represents a part of reflector 20 of a radio antenna according to an embodiment of the invention.

This reflector 20 is to a large extent of the same type as reflector 12 of the prior art represented in FIGS. 1 and 1a, but reflector 20 includes a body 22 with a solid front skin, and decoupling angles 24 of a new type, in accordance with the invention.

In what follows, the terms “front”, “rear” and “side” are used in reference to the antenna's transmission direction.

In a known manner, the shape of body 22 of reflector 20 is roughly that of a paraboloid of revolution around an axis of the reflector.

The front skin (not visible in FIG. 2) of body 22 is made from a conventional composite material, of the type including a fabric of structural fibres, for example carbon, sunk in an epoxy or comparable resin.

The structural fibres of the front skin are woven so as to provide an optimal isotropy of the mechanical properties of front skin 22, and such that front skin 22 is solid. To accomplish this the structural fibres are, for example, positioned in the form of two sheets of taffeta fabrics intersecting at angles of 45 degrees, or in the form of three to six sheets of layers of fibres draped symmetrically) (0°, +60°, −60°). This type of structure notably enables the precision and the stability over time of the profile of the front skin to be optimised.

Body 22 also includes a rear skin 28 which is made from a composite material comparable to the one, described above, of the front skin, which thus has the same advantages.

Reflector 20 includes a rigid rear structure 28 formed of tubular elements 29 of roughly rectangular section, and similar to rear structure 16 of reflector 12 of the prior art.

Rear structure 28 is connected to body 22 of the reflector by angles 24, which each include a central metal blade 30. An end of blade 30 includes a first base 32 for attachment to rear skin 26 of body 22, and another end of blade 30 is attached to a flexible metal blade 34 attached to a side face 36 of a tubular element 29 of rear structure 28.

In a known manner, flexible blade 34 and, to a lesser degree, central blade 30, allow by their elasticity the transverse component, i.e. that perpendicular to the axis of body 22, of vibrations of this body 22 to be dampened.

According to the invention, each angle 24 also includes a layer of elastic material 38, interposed between base 32 of the angle and rear skin of body 22, to dampen the axial component of any vibrations of body 22.

In the embodiment represented in FIG. 2, elastic material 38 is a polyimide foam chosen such that it does not deteriorate at temperatures of between −180° C. and +200° C., and in order to satisfy the space standards relative to degassing, typically specifying a total mass loss (TML) of less than 1% approximately.

Said foam is also chosen to have thermomechanical properties such that the foam affects the thermomechanical properties of reflector 20 as little as possible. In particular, the foam is chosen to have the lowest possible thermoelastic coefficient.

In addition, the polyimide foam has a density of between 10 kg/m³ and 20 kg/m³, a traction resistance of between 0.1 MPa and 0.5 MPa, a Young's modulus of between 0.25 MPa and 1 MPa, and a breaking elongation of between 20% and 40%. The abovementioned physical parameters are chosen in accordance with the level of dampening and mechanical decoupling required between body 22 and rear structure 28 of the reflector.

As variant or in addition, each angle 24 can include a layer of elastic material of the type described above, interposed between central blade 30 of angle 24 and rear structure 28 of the reflector.

In this case, it is preferable that each angle 24 is attached to a front face 40 of a tubular element 29 of rear structure 28, for example by a second base similar to the abovementioned first base 32, and connected to the end of central blade 30 opposed to said end comprising the first base 32. The layer of foam can thus be interposed between the second base and front face 40 of tubular element 29, to allow satisfactory dampening of the axial component of vibrations of body 22.

As another variant, the layer of elastic material may be incorporated in a sandwich structure, and may in particular be inserted between two solid skins, for example of a type comparable to the type of the skins of body 22. With respect to the attachment of angles 24 to rear skin 26 of the reflector, this characteristic notably allows a method of attachment to be used similar to a conventional method of attachment of angles of reflectors of a known type.

It is also possible, without going beyond the scope of the invention, to replace the polyimide foam by a flexible adhesive consisting of elastomer or silicon, or again consisting of polyurethane.

In the represented embodiment, rear structure 28 is of the tubular type, but the invention is also compatible with rear structures of other types, such as flat, paraboloid or comparable structures, for example of the composite sandwich type.

The shape of the front skin of the reflector can, of course, be different from the one described above as an example, without going beyond the scope of the invention.

1-10. (canceled)

11. A radio antenna, particularly for a spacecraft, including a reflector and means of support of this reflector, where the reflector includes a body able to reflect radio waves, and a rigid rear structure supported by the means of support and connected to the body by decoupling angles distributed around an axis of the body and each including a first base attached to the body of the reflector, a flexible metal blade or a second base attached to the rigid rear structure and a central metal blade connecting said first base to said flexible metal blade or to said second base and able to dampen a transverse component of vibrations of the body, wherein each of said decoupling angles includes, at one at least of its ends, a layer of elastic material able to dampen at least one axial component of vibrations of the body, where said layer of elastic material is interposed between said first base and the body, or between said flexible metal blade or said second base and the rigid rear structure.

12. An antenna according to claim 11, wherein the body includes a solid front skin.

13. An antenna according to claim 11, wherein said elastic material has a Young's modulus of between 0.25 MPa and 1 Mpa.

14. An antenna according to claim 11, wherein said elastic material has a traction resistance of between 0.1 MPa and 0.5 Mpa.

15. An antenna according to claim 11, wherein said elastic material has a breakage elongation of between 20% and 40%.

16. An antenna according to claim 11, wherein said elastic material is a foam.

17. An antenna according to claim 16, wherein said elastic material includes at least one compound belonging to the group of polyimides.

18. An antenna according to claim 16, wherein each of said decoupling angles includes at least one sandwich structure including two skins made from composite material affixed either side of said layer of elastic material.

19. An antenna according to claim 11, wherein said elastic material includes an adhesive including an elastomer, silicon or polyurethane compound.

20. An antenna according to claim 11, configured to operate in a predetermined frequency band of the microwave spectrum within the Ka band.
